(19) United States
(12) Patent Application Publication
(10) Pub. No.: US 2010/0287289 A1
(43) Pub. Date: Nov. 11, 2010

(54) METHOD AND SYSTEM OF SECURING ELECTRONIC DEVICE

(75) Inventors: Chih-Jung Peng, Tu-Cheng (TW); Peng-Zheng Yang, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/534,138

(22) Filed: Aug. 2, 2009

(30) Foreign Application Priority Data
May 11, 2009 (CN) 200910302212.4

(51) Int. Cl. G06F 15/16

(52) U.S. Cl. 709/229; 709/238; 709/227

(57) ABSTRACT

A method of securing electronic device includes connecting a first electronic device saving an initial network environment parameter to a network. The first electronic device detects an actual network environment parameter in the network. The first electronic device uploads data information stored therein to a predetermined second electronic device through the network when the actual network environment parameter is different from the initial network environment parameter. The first electronic device deletes the data information stored therein.

### BACKGROUND

1. Technical Field

The present disclosure relates to a method and a system of securing electronic device and, particularly, to a method and a system of securing electronic device in a network.

2. Description of Related Art

An electronic device has some important data information stored therein for users. A user can obtain the data information from the electronic device after the user is authorized. However, the data information may be obtained by others unauthorized. The data information stored in the electronic device is not safe. The data information may easily be obtained by others.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a diagram of a system of securing electronic device.

FIG. 2 is a block view of a system of securing electronic device.

FIG. 3 is a flow chart of a method of securing electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

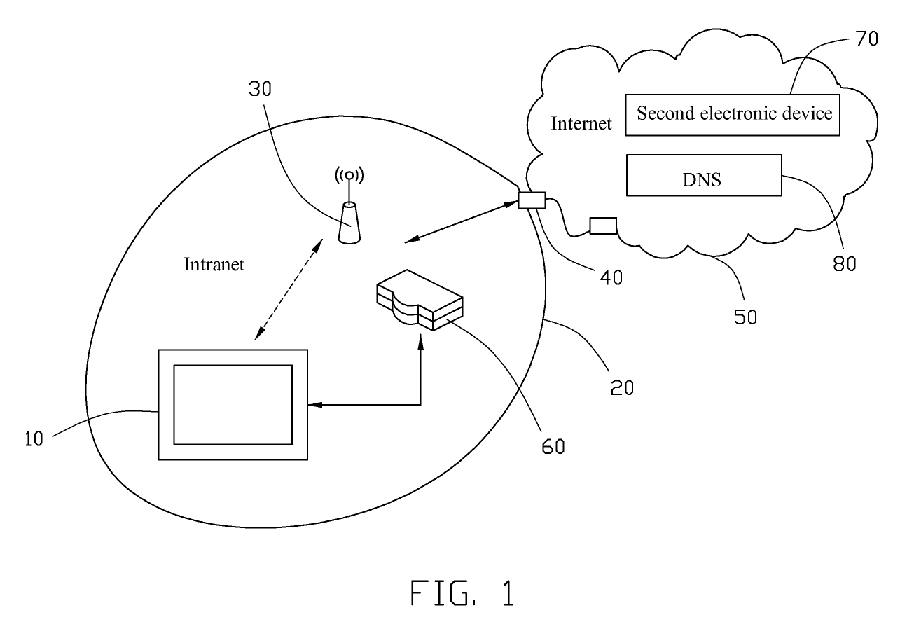

Referring to FIG. 1, a system of securing electronic device includes a first electronic device 10. The first electronic device 10 may be a digital photo frame. The first electronic device is located in an Intranet 20. The first electronic device 10 may connect with a wireless access point 30. The wireless access point 30 connects with the Internet 50 via a public IP address 40. The first electronic device 10 may connect with a gateway 60 or a router. The gateway 60 connects to the Internet 50 through the public IP address 40. A second electronic device 70 is connected with the first electronic device 10. The second electronic device 70 may be a certification server. The second electronic device 70 and a Domain Name Server (DNS) 80 are located in the Internet 50.

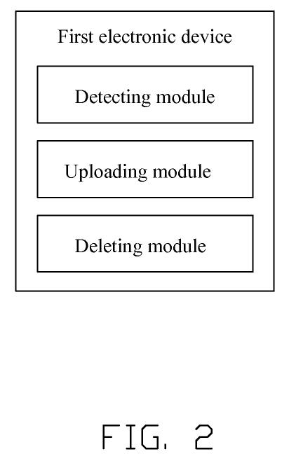

Referring to FIG. 2, the first electronic device 10 includes three modules, a detecting module, a deleting module, and an uploading module. The first electronic device 10 stores a plurality of initial network environment parameters. The detecting module is capable of detecting actual network environment parameters and comparing with the initial network environment parameters. The uploading module is capable of uploading data information stored in the first electronic device 10 to the second electronic device 70 when the actual network environment parameters are different from the initial network environment parameters. The deleting module is capable of deleting the data information after the uploading module uploads the data information.

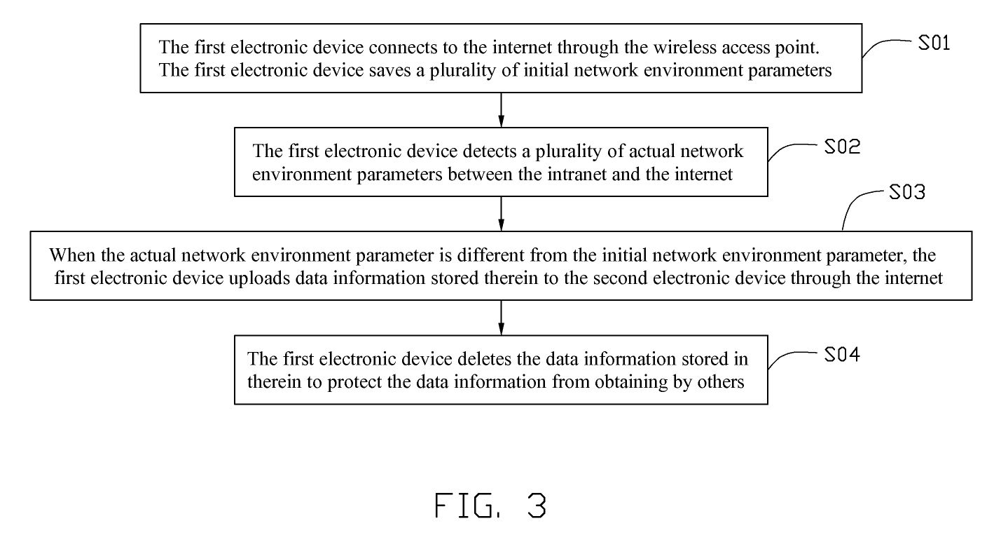

FIG. 3 is a flowchart illustrating one embodiment of a method for securing electronic device. Depending on the embodiment, additional blocks in the flow of FIG. 3 may be added, others removed, and the ordering of the blocks may be changed.

In block S01, the first electronic device 10 connects to the Internet 50 through the wireless access point 30 (or the gateway 60). The first electronic device 10 saves a plurality of initial network environment parameters.

In block S02, the detecting module of the first electronic device 10 detects a plurality of actual network environment parameters between the Intranet 20 and the Internet 50. The initial and actual network environment parameters include:

1. a name of the wireless access point 30 or a Media Access Control (MAC) address of the wireless access point 30.

2. all IP addresses in the Intranet 20 and at least one public IP address in the Internet 50 of a route path between the first electronic device 10 and the second electronic device 70. When one IP address in the Intranet 20 is changed, the actual network environment parameter is not different from the initial network environment parameter.

3. a MAC address of the gateway 60.

4. a domain name of the first electronic device 10 by the inquiring DNS server 80.

5. the actual network environment parameter comprising sudden disconnected network, the initial network environment parameter comprising normal connected and disconnected network.

In block S03, when the actual network environment parameter is different from the initial network environment parameter, the uploading module of the first electronic device 10 uploads data information stored therein to the second electronic device 70 through the Internet 50. The network environment parameters generally can not be changed except when someone intends to change the network environment parameters. When the first electronic device 10 detects the initial network environment parameter changed, the uploading module of the first electronic device 10 uploads data information stored therein to the second electronic device 70. The data information includes MAC address, photos, music, and movie and so on in the first electronic device 10. The first electronic device 10 may upload the data information through a protocol, for example, FTP protocol, EMAIL protocol, MMS protocol, HTTP protocol. When the first electronic device 10 disconnects with the network 50, the first electronic device 10 uploads the data information via WiFi.

In block S04, the deleting module of the first electronic device 10 deletes the data information stored in therein to protect the data information from obtaining by others. If a user uses the first electronic device 10 again, the second electronic device 70 must authorize the user to obtain the data information from the first electronic device 10.

It is to be understood, however, that even though numerous characteristics and advantages of the disclosure have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. A method of securing electronic device, comprising:
connecting a first electronic device to a network, wherein the first electronic device comprising an initial network environment parameter;
detecting an actual network environment parameter of the first electronic device in the network;
determining if the actual network environment parameter is different from the initial network environment parameter;
uploading data information stored in the first electronic device to a predetermined second electronic device through the network when the actual network environment parameter is different from the initial network environment parameter;
deleting the data information stored in the first electronic device.

2. The method of claim 1, wherein the first electronic device connects to the network via a wireless access point; the actual and initial network environment parameters comprise a name of the wireless access point.

3. The method of claim 2, wherein the actual and initial network environment parameters comprise Media Access Control (MAC) address of the wireless access point.

4. The method of claim 1, wherein the actual and initial network environment parameters comprise IP addresses of a route path between the first and second electronic device.

5. The method of claim 4, wherein the network comprises an Intranet and an Internet; the IP addresses comprise all IP addresses in the Intranet and at least one public IP address in the Internet.

6. The method of claim 1, wherein the first electronic device connects to the network through a gateway; the actual and initial network environment parameters comprise a MAC address of the gateway.

7. The method of claim 1, wherein a Domain Name Server (DNS) is set in the network; the actual and initial network environment parameters comprise a domain name of the first electronic device.

8. The method of claim 1, wherein the actual network environment parameter comprises sudden disconnected network, the initial network environment parameter comprises normal connected and disconnected network.

9. The method of claim 1, wherein the second electronic device authorizes the first electronic device to obtain the data information after the data information is uploaded to the second electronic device.

10. The method of claim 1, wherein the first electronic device is a digital photo frame.

11. A system of securing electronic device, comprising:
a first electronic device capable of saving an initial network environment parameter and connecting to a network, the first electronic device comprising:
a detecting module capable of detecting an actual network environment parameter in the network and comparing the actual network environment parameter with the initial network environment parameter;
an uploading module capable of uploading data information stored in the first electronic device to a second electronic device in the network when the actual network environment parameter is different from the initial network environment parameter;
a deleting module capable of deleting the data information stored in the first electronic device.

12. The system of claim 11, wherein the first electronic device is connected to the network via a wireless access point; the actual and initial network environment parameters comprise a name of the wireless access point.

13. The system of claim 12, wherein the actual and initial network environment parameters comprise Media Access Control (MAC) address of the wireless access point.

14. The system of claim 11, wherein the actual and initial network environment parameters comprise IP addresses of the route path between the first and second electronic device.

15. The system of claim 14, wherein the network comprises an Intranet and an Internet; the IP addresses comprise all IP addresses in the Intranet and at least one public IP address in the Internet.

16. The system of claim 11, wherein the first electronic device is connected to the network by a gateway; the actual and initial network environment parameters comprise MAC address of the gateway.

17. The system of claim 11, wherein a Domain Name Server (DNS) is set in the network; the actual and initial network environment parameters comprise a domain name of the first electronic device.

18. The system of claim 11, wherein the actual network environment parameter comprises sudden disconnected network, the initial network environment parameter comprises normal connected and disconnected network.

19. The system of claim 11, wherein the second electronic device is capable of authorizing the first electronic device to obtain the data information after the data information is uploaded to the second electronic device.

20. The system of claim 11, wherein the first electronic device is a digital photo frame.
